(19) United States
(12) Patent Application Publication
(10) Pub. No.: US 2019/0325093 A1
(43) Pub. Date: Oct. 24, 2019

(54) VISUAL DEBUGGING, SIMULATION, AND VALIDATION OF HYBRID CONTROL SYSTEM CONFIGURATION WITH REWIND, PLAY BACK, AND PLAY FORWARD CAPABILITY

(71) Applicant: Honeywell International Inc., Morris Plains, NJ (US)

(72) Inventors: James Schreder, Perkasie, PA (US); Antoine Guillot, Doylestown, PA (US)

(21) Appl. No.: 15/960,145

(22) Filed: Apr. 23, 2018

(51) Int. Cl. G06F 17/50; G06F 11/36; G06F 3/0481

(52) U.S. Cl. CPC G06F 17/5009; G06F 3/0481; G06F 11/362

(57) ABSTRACT

A method in an industrial process control system comprises creating a control strategy for an industrial process, running a simulation of the control strategy, and rewinding the simulation of the control strategy. Rewinding the control strategy includes setting the simulation to a previous point in time of the simulation. The method further includes displaying the simulation on a display. The method can further comprise capturing process variable states from an online process and fast forwarding the simulation of the control strategy, wherein fast forwarding the control strategy includes progressing the simulation forward from a state represented by the captured process variable states.

### TECHNICAL FIELD

This disclosure relates generally to industrial process control and automation systems. More specifically, this disclosure relates to systems and methods for visual debugging, simulation, and validation of hybrid control systems.

### BACKGROUND

Industrial process control and automation systems are routinely used to automate large and complex industrial processes. These types of systems typically include sensors, actuators, and controllers, and may include algorithms and control strategies created to control and monitor the system. Hybrid controllers support control strategies of many types, including continuous, discrete, and sequential control strategies.

### SUMMARY

This disclosure provides systems and methods for visual debugging, simulation, and validation of hybrid control systems.

In a first embodiment, a method includes creating a control strategy for an industrial process, running a simulation of the control strategy, rewinding the simulation of the control strategy, wherein rewinding the control strategy includes setting the simulation to a previous point in time of the simulation, and displaying the simulation on a display.

In a second embodiment, a system includes a display and a controller configured to create a control strategy for an industrial process, run a simulation of the control strategy, rewind the simulation of the control strategy, wherein rewinding the control strategy includes setting the simulation to a previous point in time of the simulation, and cause the display to display the simulation.

In a third embodiment, a non-transitory computer readable medium embodies a computer program, and the computer program includes computer readable program code that when executed causes at least one processing device to create a control strategy for an industrial process, run a simulation of the control strategy, rewind the simulation of the control strategy, wherein rewinding the control strategy includes setting the simulation to a previous point in time of the simulation, and cause a display to display the simulation.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates a portion of an example industrial process control and automation system according to this disclosure;

FIG. 2 illustrates an example operator station that implements a tool that can be used to provide visual testing and debugging according to this disclosure;

FIG. 3 illustrates an example model of a system for building, testing, and debugging of control strategies according to this disclosure;

FIG. 4 illustrates an example block diagram of a visual debugging environment according to this disclosure;

FIG. 5 illustrates an example visual debugging environment for a continuous control strategy according to this disclosure;

FIG. 6 illustrates an example visual debugging environment for a sequential control strategy according to this disclosure; and

FIG. 7 illustrates a diagram of an example method for building, testing, and debugging of control strategies according to this disclosure.

### DETAILED DESCRIPTION

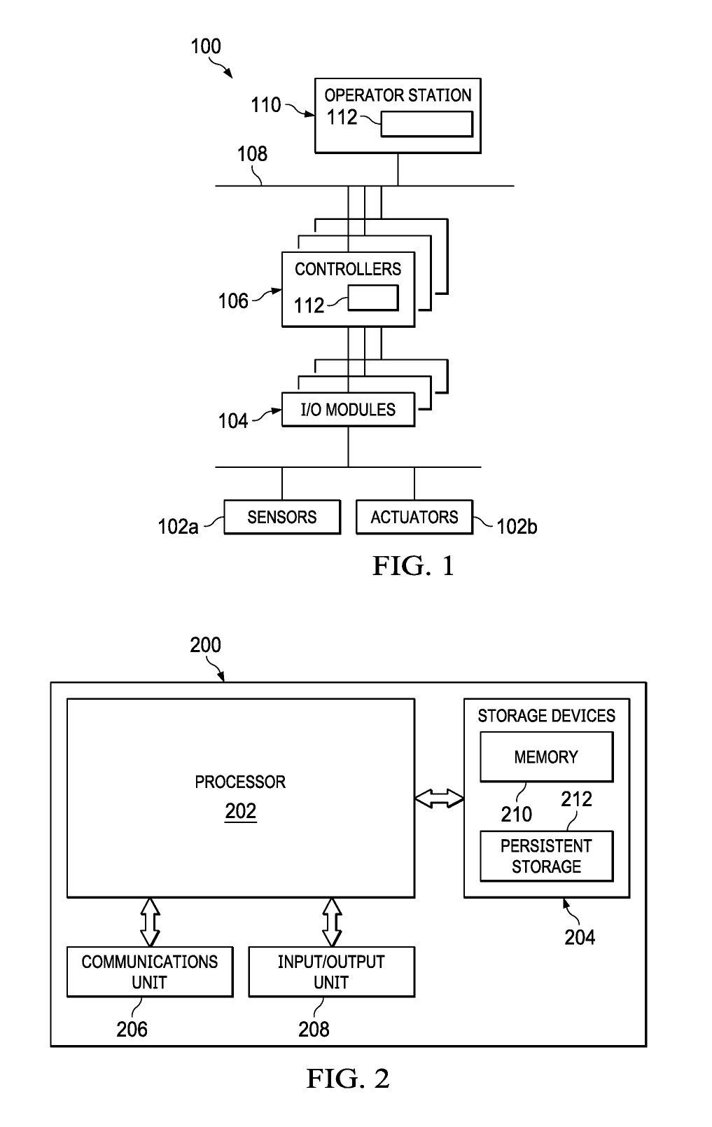

FIGS. 1 through 6, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

Embodiments of the present disclosure contemplate that the time allocated to build new industrial plants and to bring expansions to industrial plants is continually decreasing, putting increased pressure on establishing, testing, and validating that the control system for these plants works as designed. The present disclosure includes systems and methods for testing and debugging a hybrid control system configuration in a minimal amount of time.

The testing and debugging system of the present disclosure provides the ability to debug in a simulation environment with simulated values, in a live environment with live values in parallel with online control strategies, or in an offline environment with a captured set of live values. Some embodiments of the system provide the ability to visually set breakpoints using a graphical view of control strategies under test, where breakpoint types can include before or after block (or statement) breakpoints, conditional breakpoints, and a combination of the two. Additionally, some embodiments of the system provide automatic default and customizable watch windows for process values, with the ability to read and write values through the watch windows. The values can be written as an expression in some embodiments. The system can also provide the ability to save and recall breakpoints and watch windows across debug sessions.

In further embodiments of the testing and debugging system of the present disclosure, execution control features, including stepping to the next block, stepping in (to a block), stepping over a block, moving the current execution pointer to a new location, and conditional execution. For sequential (or procedural) control strategies, the system can provide the ability to visually set an execution path to be taken at branch points in the control strategy.

Some embodiments of the testing and debugging system of the present disclosure provide the capability to rewind a simulation to a previous point of execution, and to “play back” the simulation from that point using snapshots of process variables from that point in time. Additionally, the system can provide the capability to “fast forward” a process, executing a simulation into the future based on present process variable values and conditions in an online process.

FIG. 1 illustrates a portion of an example industrial process control and automation system 100 according to this disclosure. As shown in FIG. 1, the system 100 includes various components that facilitate production or processing of at least one product or other material. For instance, the system 100 can be used to facilitate control or monitoring of components in one or multiple industrial plants. Each plant represents one or more processing facilities (or one or more portions thereof), such as one or more manufacturing facilities for producing at least one product or other material. In general, each plant may implement one or more industrial processes and can individually or collectively be referred to as a process system. A process system generally represents any system or portion thereof configured to process one or more products or other materials or energy in different forms in some manner.

In the example shown in FIG. 1, the system 100 includes one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. Each of the sensors 102a includes any suitable structure for measuring one or more characteristics in a process system. Each of the actuators 102b includes any suitable structure for operating on or affecting one or more conditions in a process system.

At least one input/output (I/O) module 104 is coupled to the sensors 102a and actuators 102b. The I/O modules 104 facilitate interaction with the sensors 102a, actuators 102b, or other field devices. For example, an I/O module 104 could be used to receive one or more analog inputs (AIs), digital inputs (DIs), digital input sequences of events (DISOEs), or pulse accumulator inputs (PIs) or to provide one or more analog outputs (AOs) or digital outputs (DOs). Each I/O module 104 includes any suitable structure(s) for receiving one or more input signals from or providing one or more output signals to one or more field devices. Depending on the implementation, an I/O module 104 could include fixed number(s) and type(s) of inputs or outputs or reconfigurable inputs or outputs.

The system 100 also includes various controllers 106. The controllers 106 can be used in the system 100 to perform various functions in order to control one or more industrial processes. For example, a first set of controllers 106 may use measurements from one or more sensors 102a to control the operation of one or more actuators 102b. These controllers 106 could interact with the sensors 102a, actuators 102b, and other field devices via the I/O module(s) 104. The controllers 106 may be coupled to the I/O module(s) 104 via Ethernet, backplane communications, serial communications, or the like. A second set of controllers 106 could be used to optimize the control logic or other operations performed by the first set of controllers. A third set of controllers 106 could be used to perform additional functions.

Controllers 106 are often arranged hierarchically in a system. For example, different controllers 106 could be used to control individual actuators, collections of actuators forming machines, collections of machines forming units, collections of units forming plants, and collections of plants forming an enterprise. A particular example of a hierarchical arrangement of controllers 106 is defined as the “Purdue” model of process control. The controllers 106 in different hierarchical levels can communicate via one or more networks 108 and associated switches, firewalls, and other components.

Each controller 106 includes any suitable structure for controlling one or more aspects of an industrial process. At least some of the controllers 106 could, for example, represent proportional-integral-derivative (PID) controllers or multivariable controllers, such as Robust Multivariable Predictive Control Technology (RMPCT) controllers or other types of controllers implementing model predictive control (MPC) or other advanced predictive control. As a particular example, each controller 106 could represent a computing device running a real-time operating system, a MICROSOFT WINDOWS operating system, or other operating system.

Operator access to and interaction with the controllers 106 and other components of the system 100 can occur via various operator stations 110. Each operator station 110 could be used to provide information to an operator and receive information from an operator. For example, each operator station 110 could provide information identifying a current state of an industrial process to an operator, such as values of various process variables and warnings, alarms, or other states associated with the industrial process. Each operator station 110 could also receive information affecting how the industrial process is controlled, such as by receiving setpoints for process variables controlled by the controllers 106 or other information that alters or affects how the controllers 106 control the industrial process. Each operator station 110 includes any suitable structure for displaying information to and interacting with an operator.

The system 100 can include a testing and debugging system. In to accordance with this disclosure, at least one tool 112 is provided that can be used to provide visual testing and debugging, as will be further described below. The tool 112 could be implemented in any suitable manner. For example, the tool 112 could be implemented using hardware or a combination of hardware and software/firmware instructions. In this example, one instance of the tool 112 is implemented on an operation station 110. However, the tool 112 could be implemented using any suitable device(s). For example, an instance of the tool 112 could also be located in a controller 106. In some embodiments, tools 112 in the operator station 110 and in a controller 106 can operate together to perform the functions of the testing and debugging system described below.

This represents a brief description of one type of industrial process control and automation system that may be used to manufacture or process one or more materials. Additional details regarding industrial process control and automation systems are well-known in the art and are not needed for an understanding of this disclosure. Also, industrial process control and automation systems are highly configurable and can be configured in any suitable manner according to particular needs.

Although FIG. 1 illustrates a portion of one example industrial process control and automation system 100, various changes may be made to FIG. 1. For example, various components in FIG. 1 could be combined, further subdivided, rearranged, or omitted and additional components could be added according to particular needs. Also, while FIG. 1 illustrates one example operational environment in which visual testing and debugging could be used, this functionality could be used in any other suitable system.

FIG. 2 illustrates an example operator station 200 that implements a tool that can be used to provide visual testing and debugging according to this disclosure. For ease of explanation, the operator station 200 is described as being used in the industrial process control and automation system 100 of FIG. 1. However, the operator station 200 could be used in any other suitable system. Among other things, the example operator station 200 may use the measurements from the one or more sensors 102a to control the operation of one or more actuators 102b, along with other environmental data captured by the system 100. In some embodiments, a controller 106 could perform some or all of the below described functions of the operator station 200, particularly those pertaining to the tool that can be used to provide visual testing and debugging.

As shown in FIG. 2, the operator station 200 includes at least one processor 202, at least one storage device 204, at least one communications unit 206, and at least one input/output (I/O) unit 208. Each processor 202 can execute instructions, such as those that may be loaded into a memory 210. Each processor 202 denotes any suitable processing device, such as one or more microprocessors, microcontrollers, digital signal processors, application specific integrated circuits (ASICs), field programmable gate arrays (FPGAs), or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory, a buffer or cache, or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. For example, the communications unit 206 could include at least one network interface card or wireless transceiver facilitating communications over at least one wired or wireless network, such as the network 108. The communications unit 206 may support communications through any suitable physical or wireless communication link(s).

The I/O unit 208 allows for input and output of data. For example, the I/O unit 208 may provide a connection for user input through a keyboard, mouse, keypad, touchscreen, or other suitable input device. The I/O unit 208 may also send output to a display, printer, or other suitable output device. The user input and output devices for controllers that interface with an operator may, for example, be included in the operator station 200.

Although FIG. 2 illustrates one example of an operator station 200 for implementing a tool that can be used to provide visual testing and debugging, various changes may be made to FIG. 2. For example, various components in to FIG. 2 could be combined, further subdivided, rearranged, or omitted and additional components could be added according to particular needs. Also, computing devices come in a wide variety of configurations, and FIG. 2 does not limit this disclosure to any particular configuration of computing device.

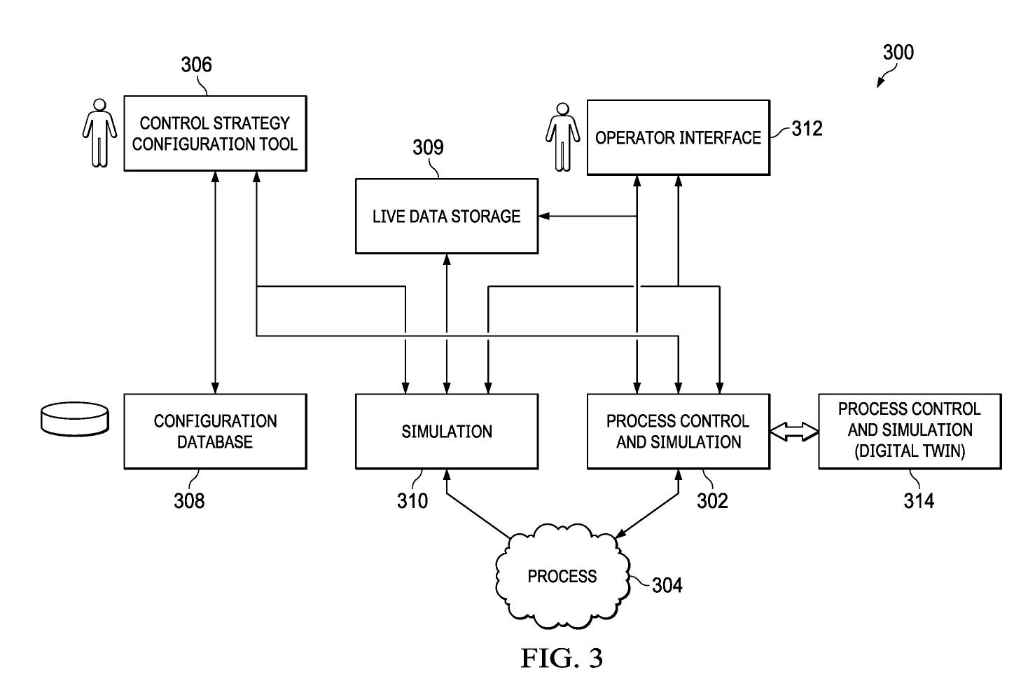

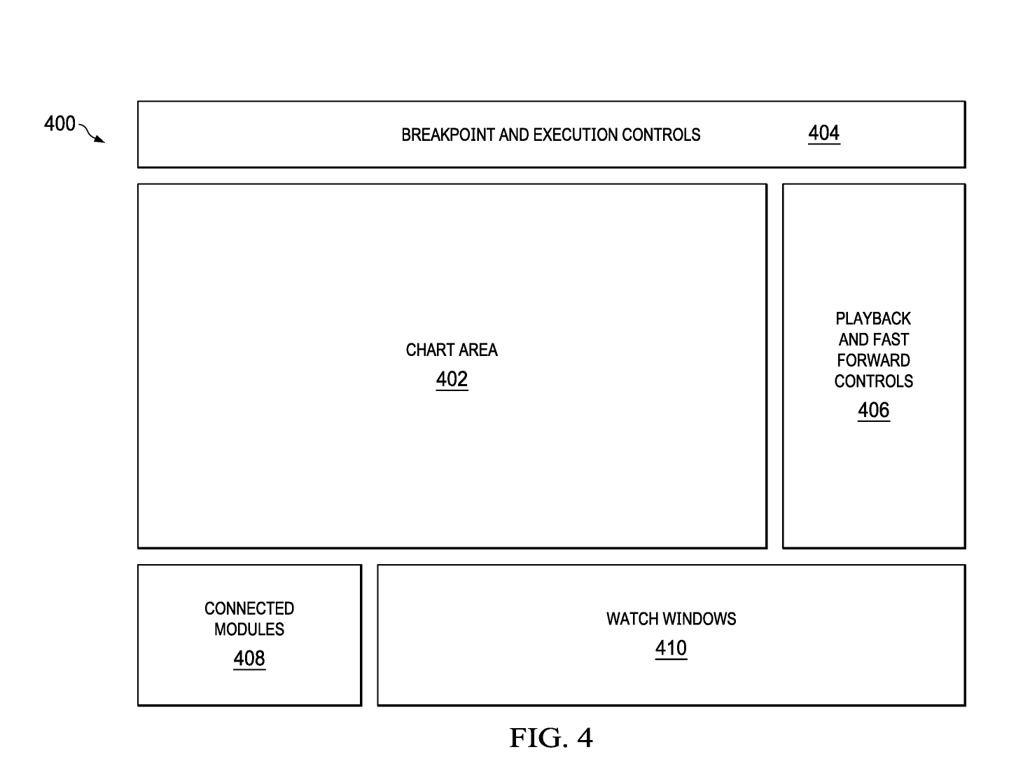

FIG. 3 illustrates an example model of a system 300 for building, testing, and debugging of control strategies according to this disclosure. For simplicity, the system 300 will be discussed in the context of designing, testing, and debugging control strategies for the system 100, but it is understood that the system 300 could be applied to any suitable control system.

The system 300 includes a controller 302 for implementing process controls on a process 304. In some embodiments, the controller 302 performs the functions of a controller 106 of the system 100. The controller 302 can additionally run simulations alongside controlling the live process 304. The controller 302 interfaces with a control strategy configuration tool 306, which provides control strategies to the controller 302 for implementation in the process 304.

The control strategy configuration tool 306 additionally facilitates design and debugging of control strategies, for example by an operator (such as a control engineer). Previously designed control strategies can be stored in a configuration database 308 for later retrieval by the control strategy configuration tool 306 for implementation via the controller 302. The control strategy configuration tool 306 additionally interfaces with a simulation environment 310 that is attached to the process 304. The simulation environment 310 can read live data from the process 304 for use in simulation, but cannot write any data back to the process 304 (i.e., the simulation environment 310 cannot modify the process 304). The simulation environment 310 (or the process control and simulation environment 302) can also capture live data from the process 304 and store it, for example in a live data storage component 309, for later use running a simulation based on captured live data. In other embodiments, the captured live data could be stored alongside a control strategy in the configuration database 308.

The control strategy configuration tool 306 and simulation environment 310 can be used for validation of a control strategy. That is, a control strategy can be designed and implemented in a simulation to validate that the control strategy produces expected results. Such validation can, for example, be used to to determine that a control strategy is ready to be implemented in an online environment (e.g., process 304). If a control strategy does not produce expected results, then the validation fails and the control strategy configuration tool 306 can be used to perform debugging on the control strategy, as will be described further below.

In some embodiments, an operator interface 312 may interface with the controller 302 and/or the simulation environment 310 separately from the control strategy configuration tool 306. This could be, for example, an operator station 110 that does not contain the tool 112 for providing testing and debugging functions.

In some embodiments, a digital twin 314 of the controller 302 is a virtual copy of the controller 302. The digital twin 314 can perform the functions of capturing live values (or live data) from the process 304 for use in running simulations of the process 304 in parallel with the process 304. As described further below, such real-time simulations can be used with a fast forwarding function to predict future states of the process 304 in real time based on the live data coming from the process 304. In some embodiments, this functionality is included in the simulation environment 310.

Although FIG. 3 illustrates one example of a system 300 of components involved in building, testing, and debugging of control strategies, various changes may be made to FIG. 3. For example, various components in FIG. 3 could be combined, further subdivided, rearranged, or omitted and additional components could be added according to particular needs.

FIG. 4 illustrates an example block diagram of a visual debugging environment 400 according to this disclosure. For simplicity, the debugging environment 400 will be discussed in the context of the system 300, but it is understood that the visual debugging environment 400 could be used in any appropriate system.

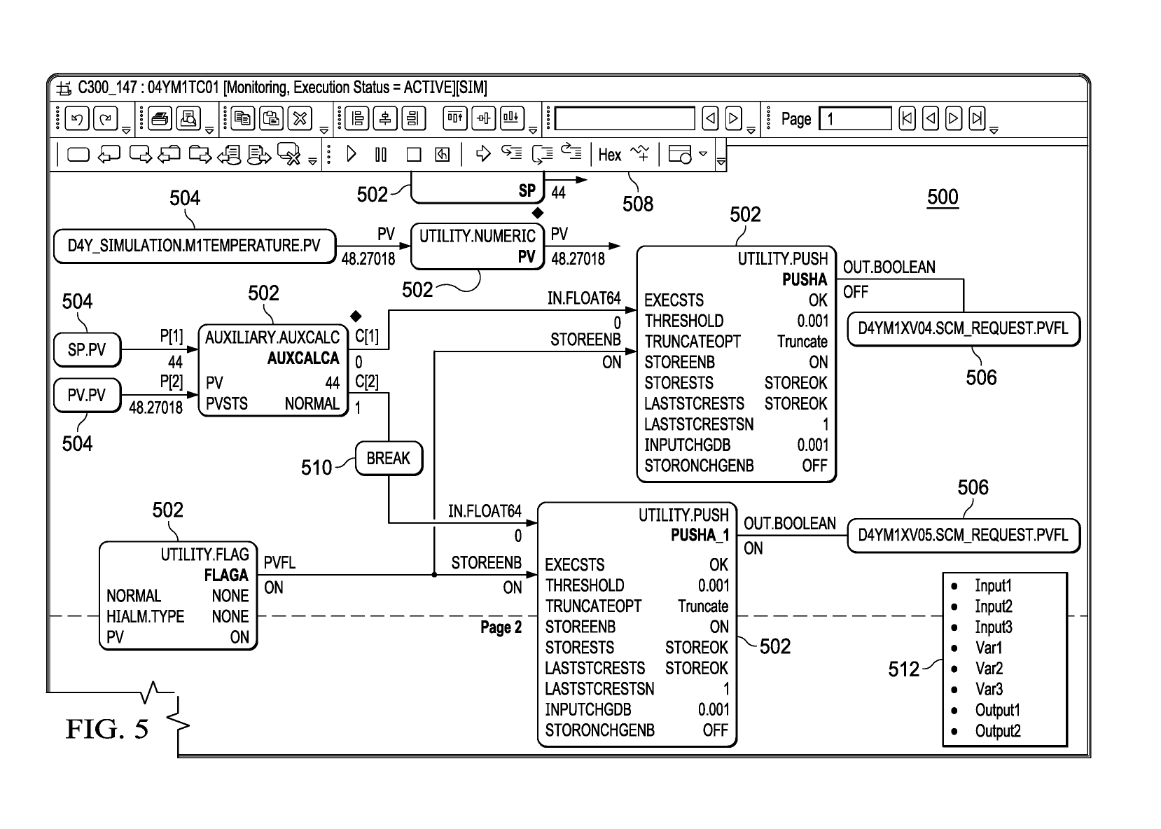

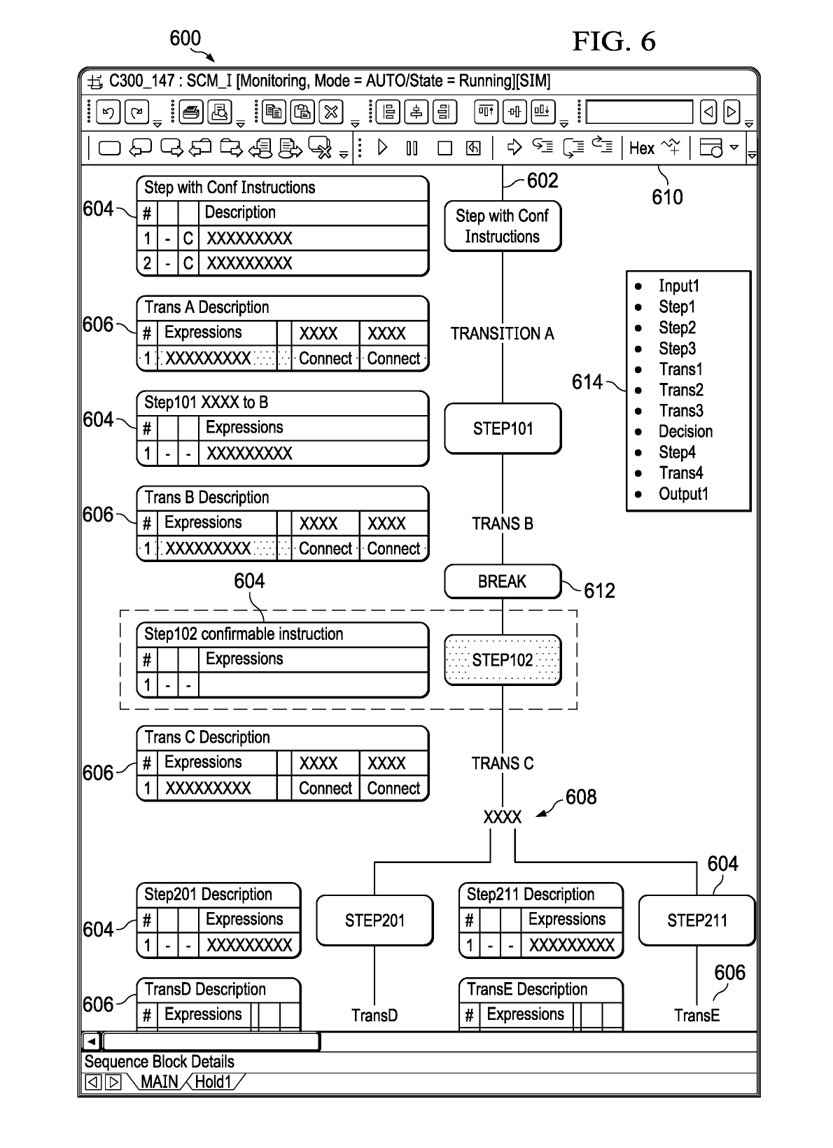

In this embodiment, the chart area 402 represents an area of the environment 400 where control strategy blocks and interconnections are visually represented. As will be further described below with respect to FIGS. 5 and 6, the visual representation of the control strategy could include various function blocks, interconnections between the function blocks, inputs, outputs, and the like.

Breakpoint and execution controls 404 include controls that allow for setting breakpoints, stepping forward (i.e., running the simulation until data reaches a next function), stepping in or over (i.e., in a control strategy that allows nested processes, if a process calls another sequence, step in and pause after each step of that sequence, or step over that process by running the sequence and pausing after it finishes), and allow for use of any other appropriate debugging tools. These debugging tools allow an operator (such as a control engineer) to track down faults in a control strategy.

Playback and fast forward controls 406, as further described below, allow for control of a rewind/playback and fast forward system. The rewind system allows an engineer to set the simulation to a previous point in time, and run the simulation from that point. This can be valuable in complicated simulations that have run for long periods of time (e.g., hours or days) to get to a state where debugging is desired. If a simulation has progressed past a point where a fault (or some other event of interest) occurred, the engineer may wish to go back in the process and view the state of various variables or modify various variables to see what the output is. Rerunning the entire simulation to reach that state (for example, by setting a breakpoint and rerunning the simulation) could be very time consuming and costly. The rewind/play back functionality avoids this cost. To facilitate rewind/playback, data that allows reconstruction of the simulation state for a certain window of time can be continuously saved in a memory, such as a persistent storage 212, for later use.

The fast forward functionality of playback and fast forward controls 406 can be used with simulations running in parallel with an online process, and can allow simulations into the future to allow predictions of process state in the future based on live data coming from the process. In some cases, this could allow detection of faults or suboptimal conditions, and an engineer can use this knowledge to adjust process parameters of the online process in real-time.

The connected modules window 408 can contain a list of control strategies that provide data to or consume data from the control strategy displayed in the chart area. The watch windows 410 display monitored values and allow values to be set or changed for debugging purposes. For example, an engineer can assess the state of a simulation of the control strategy in the chart area 402 and determine whether faults have occurred. This can be useful to isolate the point in time in a simulation where a fault occurs, as well as the location within the control strategy where the fault occurs. In some embodiments, as described below, the engineer may be able to use the watch windows 410 to modify data within the simulation for debugging purposes, and may additionally be able to write an expression to determine the value of a variable to be modified, so that the value of the modified variable changes dependent on the state of the simulation.

FIG. 5 illustrates an example visual debugging environment 500 for a continuous control strategy according to this disclosure. For simplicity, the debugging environment 500 will be discussed in the context of the system 300, but it is understood that the visual debugging environment 500 could be used in any appropriate system.

In this embodiment, a control strategy is visually represented in the debugging environment 500. Each function block 502 in the debugging environment 500 represents a function that is part of the overall control strategy. For example, a function block 502 could apply a filter to the input data, could generate an alarm for display to an operator based on a threshold for various input values, or could even represent a PID controller. Each line connecting the function blocks 502 represents a signal or data that is passed between the function blocks 502. Signals 504 that enter the function blocks on the left-most side of the debugging environment 500 represent data inputs to the control strategy from the process, and signals 506 that exit the function blocks on the right-most side of the debugging environment 500 represent data outputs from the control strategy that could go to another control strategy, or could go out to a live process environment to affect a change in process equipment (e.g., modifying flow rate of a piece of process equipment).

In some embodiments, during debugging, a debugging tool set 508 is visually displayed to an operator (such as a control engineer) that is performing debugging. The debugging tool set 508 allows the engineer to select various debugging tools, such as breakpoints, watch windows, step forward (i.e., run the simulation until data reaches the next block), rewind/play back, and fast forward commands. As described above with reference to FIG. 4, one or more of these functions may have its own window or toolbar in the environment 500. The debugging tool set 508 can also allow the engineer to set values of variables or conditions for the overall control strategy, or for individual data lines in the control strategy.

An example breakpoint 510 is placed in a data line between two function blocks 502. Such a breakpoint, when inserted by the engineer using the debugging tool set 508, will pause a simulation automatically when a value of data changes along that data line. In some embodiments, the simulation will pause whenever it reaches the breakpoint, even if the value of the data on the data line does not change. In some embodiments, the breakpoint 510 is a drag-and-drop type of function that automatically determines the data it is intended to be monitoring.

A watch window 512 can then display the values of various inputs, outputs, conditions, and data lines at that moment in the simulation. From this information, the engineer can assess the state of the simulation and determine whether faults have occurred. This can be useful to isolate the point in time in a simulation where a fault occurs, as well as the location (e.g., the function) within the process where the fault occurs. The watch window 512 can also show this data in real time as the simulation is running.

In some embodiments, the debugging tool set 508 automatically determines the variables to display within a given control strategy (for example, it may choose to display only variables relevant to a block where the simulation is paused), and an engineer can modify this list to display more or less of the available information. In some embodiments, the engineer can use the watch window 512 to modify data within the simulation for debugging purposes. The engineer may be able to write an expression to determine the value of a variable to be modified, so that the value of the modified variable changes dependent on the state of the simulation.

Although FIG. 5 illustrates one example visual debugging environment 500 for a continuous control strategy, various changes may be made to FIG. 5. For example, various components in FIG. 5 could be combined, further subdivided, rearranged, or omitted and additional components could be added according to particular needs.

FIG. 6 illustrates an example visual debugging environment 600 for a sequential control strategy according to embodiments of the present disclosure. For simplicity, the debugging environment 600 will be discussed in the context of the system 300, but it is understood that the visual debugging environment 600 could be used in any appropriate system.

In a sequential control strategy, the strategy proceeds sequentially, as represented by line 602, through process steps 604 that act upon data until it reaches the output. Each process step 604 has inputs from and outputs to other process steps 604 which are not represented in the environment 500. The strategy may also encounter transition points 606 that hold the data until a condition is met before proceeding to the next process step 604. Similar to the continuous control strategy of FIG. 5, the input data can be received from a live process environment, and the output data can be output to affect the live process environment (e.g., modifying flow rate of a piece of process equipment). A sequential control strategy can also include decision points 608, which allow the control strategy to branch off into multiple paths of subsequent process steps 604 and transition points 606 based on various conditions. In some embodiments, the process may branch from a decision point 608 into multiple paths that operate simultaneously in parallel.

The visual debugging environment 600 can include a debugging tool set 610 that functions similar to the debugging tool set 508, which allows the engineer to select various debugging tools, such as breakpoints, watch windows, step forward (i.e., run the simulation until data reaches the next process step 604), step in/over (i.e., if a process step 604 calls another sequence, step in and pause after each step of that sequence, or step over that block by running the sequence and pausing after it finishes), rewind/play back, and fast forward commands. The debugging tool set 610 can also allow the engineer to set values of variables or conditions for the overall control strategy, or for individual process steps 604 or transition points 606 in the control strategy. Additionally, the debugging tool set 610 can allow the engineer to force a desired path at a decision point 608.

A breakpoint, such as breakpoint 612, can be inserted along the line 602 to stop the simulation when the strategy reaches that point, similar to the breakpoints described above with reference to FIG. 5. Also as described above, a watch window 614 can display the value of variables, conditions, and data lines at the point in the simulation where the breakpoint 612 stops the simulation. The watch window 614 can also show this data in real time as the simulation is running.

In some embodiments, the debugging tool set 610 automatically determines the variables to display within a given control strategy (for example, it may choose to display only variables relevant to a block where the simulation is paused), and an engineer can modify this list to display more or less of the available information. In some embodiments, the engineer can use the watch window 614 to modify data within the simulation for debugging purposes. The engineer may be able to write an expression to determine the value of a variable to be modified, so that the value of the modified variable changes dependent on the state of the simulation.

Although FIG. 6 illustrates one example visual debugging environment 600 for a continuous control strategy, various changes may be made to FIG. 6. For example, various components in FIG. 6 could be combined, further subdivided, rearranged, or omitted and additional components could be added according to particular needs.

In the embodiments of FIGS. 5 and 6, the debugging tool sets 508 and 610 can provide rewind/play back functionality, as described above. It is understood that, as illustrated in FIG. 3, a separate toolbar or window could also be provided for fast forward control. To facilitate rewind/playback, data that allows reconstruction of the simulation state for a certain window of time can be continuously saved in a memory, such as a persistent storage 212, for later use, as described above. For example, the state of values at every function block 502, process step 604, transition point 606, in the simulation could be saved or stored in memory, and upon rewinding to a particular point in time of the simulation, a set of values of every function block 502, process step 604, transition point 606 corresponding to that time could be loaded from the memory.

In the embodiments of FIGS. 5 and 6, the debugging tool sets 508 and 610 can provide fast forward functionality, as described above. It is understood that, as illustrated in FIG. 3, a separate toolbar or window could also be provided for fast forward control.

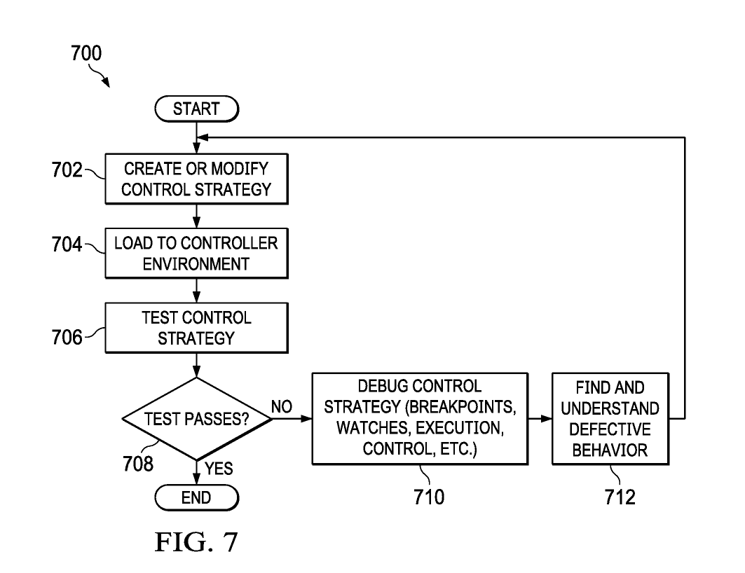

FIG. 7 illustrates a diagram of an example method 700 for building, testing, and debugging of control strategies according to this disclosure. For ease of explanation, the method 700 is described with respect to the system 300 of FIG. 3, although the method 700 could be implemented in any other suitable system. Also, the method 700 could be implemented using the debugging environments of FIGS. 5 and 6, although the method 700 could be implemented in any other suitable manner.

At step 702, a control engineer creates or modifies a control strategy. This can be done in a visual environment similar to the debugging environments of FIGS. 5 and 6, allowing the engineer to use “black box” functions that obfuscate the actual workings of the function to design a control strategy based on the known functionality of the functions.

At step 704, the control strategy is loaded into a controller environment. For example, the control strategy could be loaded into a simulation environment 310 (or onto a controller 302 running in a simulation mode) in order to validate the control strategy before putting it into use in a live process 304. The control strategy could also be loaded directly into a controller 302 for use with the live process 304 if desired.

At step 706, the control strategy is tested, for example in a simulation environment 310. This could involve running a simulation using the control strategy using predetermined simulation inputs, or using captured live data from a process 304 as inputs. For validation purposes, a known set of inputs that should result in a known set of outputs can be used.

At decision step 708, the method 700 determines if the control strategy has passed the test of step 706. This could be automated, or manually performed by the engineer or another operator. If the control strategy has passed the test of step 706, then the control strategy is validated and ready to use in a live environment, and the method 700 ends. If the test is failed, the method 700 proceeds to step 710 for debugging of the control strategy.

At step 710, the engineer performs debugging on the control strategy, for example using the debugging environments 500 or 600 of FIGS. 5 and 6, depending on whether the control strategy is continuous or sequential. Debugging could proceed as described above with respect to FIGS. 5 and 6.

At step 712, the engineer finds the undesired behavior in the control strategy and determines how to correct this behavior. The method then returns to step 702, where the engineer modifies the control strategy to attempt to correct the undesired behavior before continuing with method 700 as described above to validate the modified control strategy.

Although FIG. 7 illustrates one example of a method 700 for building, testing, and debugging of control strategies, various changes may be made to FIG. 7. For example, while shown as a series of steps, various steps in FIG. 7 could overlap, occur in parallel, or occur any number of times. As a particular example, steps 710 and 712 could occur in parallel or overlap.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
creating a control strategy for an industrial process;
running a simulation of the control strategy;
rewinding the simulation of the control strategy, wherein rewinding the control strategy includes setting the simulation to a previous point in time of the simulation; and
displaying the simulation on a display.

2. The method of claim 1, further comprising:
capturing process variable states from an online process; and
fast forwarding the simulation of the control strategy, wherein fast forwarding the control strategy includes progressing the simulation forward from a state represented by the captured process variable states.

3. The method of claim 1, further comprising:
storing simulation states and corresponding process variable states for a window of simulation time prior to a present point in time of the simulation,
wherein rewinding the control strategy includes loading one of the simulation states.

4. The method of claim 1, further comprising:
displaying, on the display, a graphical user interface (GUI) that includes a watch window, the watch window displaying values of process variables of the simulation.

5. The method of claim 4, further comprising:
setting at least one debugging breakpoint in the GUI; and
pausing the simulation when the simulation reaches the debugging breakpoint.

6. The method of claim 1, wherein the control strategy is a sequential control strategy, the method further comprising:
selecting a path at a decision point of the sequential control strategy for the simulation to follow, regardless of a state of any process variables.

7. The method of claim 1, further comprising:
setting process variables of the simulation at a point in the simulation prior to running the simulation; and
setting the process variables of the simulation when the simulation is paused at a debugging breakpoint.

8. A system comprising:
a display; and
a controller configured to:
create a control strategy for an industrial process;
run a simulation of the control strategy;
rewind the simulation of the control strategy, wherein rewinding the control strategy includes setting the simulation to a previous point in time of the simulation; and
cause the display to display the simulation.

9. The system of claim 8, wherein the controller is further configured to:
capture process variable states from an online process; and
fast forward the simulation of the control strategy, wherein fast forwarding the control strategy includes progressing the simulation forward from a state represented by the captured process variable states.

10. The system of claim 8, further comprising:
a memory,
wherein the controller is further configured to store, in the memory, simulation states and corresponding process variable states for a window of simulation time prior to a present point in time of the simulation,
wherein rewinding the control strategy includes loading one of the simulation states.

11. The system of claim 8, wherein the controller is further configured to cause the display to display a graphical user interface (GUI) that includes a watch window, the watch window displaying values of process variables of the simulation.

12. The system of claim 11, wherein the controller is further configured to:
set at least one debugging breakpoint in the GUI; and
pause the simulation when the simulation reaches the debugging breakpoint.

13. The system of claim 8, wherein the control strategy is a sequential control strategy, and wherein the controller is further configured to:
select a path at a decision point of the sequential control strategy for the simulation to follow, regardless of a state of any process variables.

14. The system of claim 8, wherein the controller is further configured to:
set process variables of the simulation at a point in the simulation prior to running the simulation; and
set the process variables of the simulation when the simulation is paused at a debugging breakpoint.

15. A non-transitory computer readable medium containing instructions that, when executed by at least one processing device, cause the at least one processing device to:
create a control strategy for an industrial process;
run a simulation of the control strategy;
rewind the simulation of the control strategy, wherein rewinding the control strategy includes setting the simulation to a previous point in time of the simulation; and
cause a display to display the simulation.

16. The non-transitory computer readable medium of claim 15, wherein the instructions, when executed by the at least one processing device, further cause the at least one processing device to:
capture process variable states from an online process; and
fast forward the simulation of the control strategy, wherein fast forwarding the control strategy includes progressing the simulation forward from a state represented by the captured process variable states.

17. The non-transitory computer readable medium of claim 15, wherein the instructions, when executed by the at least one processing device, further cause the at least one processing device to:
store simulation states and corresponding process variable states for a window of simulation time prior to a present point in time of the simulation,
wherein rewinding the control strategy includes loading one of the simulation states.

18. The non-transitory computer readable medium of claim 15, wherein the instructions, when executed by the at least one processing device, further cause the at least one processing device to:
display a graphical user interface (GUI) that includes a watch window, the watch window displaying values of process variables of the simulation.

19. The non-transitory computer readable medium of claim 18, wherein the instructions, when executed by the at least one processing device, further cause the at least one processing device to:
set at least one debugging breakpoint in the GUI; and
pause the simulation when the simulation reaches the debugging breakpoint.

20. The non-transitory computer readable medium of claim 15, wherein the control strategy is a sequential control strategy, and wherein the instructions, when executed by the at least one processing device, further cause the at least one processing device to:
select a path at a decision point of the sequential control strategy for the simulation to follow, regardless of a state of any process variables.
